(19) United States
(12) Patent Application Publication
(10) Pub. No.: US 2007/0110404 A1
(43) Pub. Date: May 17, 2007

(54) Automotive display having a function of reading data storage media

(76) Inventors: Liu Yung Ching, Yung Ho City (TW); Huang Yin Wen, Yung Ho City (TW)

Correspondence Address: PRO-TECHTOR INTERNATIONAL SERVICES, 20775 NORADA CT., SARATOGA, CA, 95070, US

(21) Appl. No.: 11/271,144

(22) Filed: Nov. 11, 2005

(51) Int. Cl. H04N 7/26

(52) U.S. Cl. 386/112

(57) ABSTRACT

An automotive display having a function of reading data storage media is disposed inside an automobile. The automotive display includes a display panel for displaying AV data and a display driving module for transmitting the AV data to the display panel for display. A data storage media reading module is electrically connected with the display driving module within the display for reading and coding digital AV data stored in a data storage medium and for transmitting the digital AV data to the display driving module for display on the display panel.

### FIELD OF THE INVENTION

The present invention relates a display, and particularly to an automotive display having a function of reading data storage media.

### BACKGROUND OF THE INVENTION

Digital products have become very widely used in modern living. For example, mobile phones having functions of taking pictures and recording videos and digital video recorders are products of digital technology. The memory of these devices, which is repeatedly read from and written to, is small in volume and can store a great quantity of digital data. The memory is a necessity of modern life now and even has replaced the compact disc, which is easily scratched and can be written on only once.

The miniaturization of the liquid crystal display (LCD) has enabled the LCD to become basic equipment inside an automobile. Current automotive displays are of different types in accordance with installation places; for example, a suspended type and an embedded type. The suspended type of display is disposed inside a roof of the automobile. The embedded type of display is disposed at a dashboard in front of the driver's seat or at a rear surface of a front seat. In installation, both types of the displays are required to electrically connect with a player disposed at the dashboard for playing media. Therefore, an AV connection line is employed as a signal transmission medium between the player and the display, whereby when the player plays a compact disc, AV signals from the player are transmitted to the display for display.

Since only a person who sits in a front seat of an automobile can operate the player, the conventional installation manner of the display allows that person to operate the player and passengers in back seats to watch the displays showing the same AV data. However, the backseat passengers cannot control the display to show different AV data in accordance with their interests. Furthermore, in installation, the AV connection line employed as a transmission medium between the player and the display increases assembly time and complication of the display and is easily shaken when driving, which adversely affects reading quality of the read head of the player.

### SUMMARY OF THE INVENTION

An object of the present invention is to provide an automotive display having a function of reading data storage media, which is disposed with at least one data storage medium reading module for reading and coding digital audio/video (AV) data stored in a data storage medium, thereby achieving a combination of a play system and a display and so simplifying assembly of the display.

To achieve the above object, an automotive display having a function of reading data storage media of the present invention includes a display panel for displaying AV data and a display driving module for transmitting the AV data to the display panel for display. A data storage media reading module is electrically connected with the display driving module within the display for reading and coding digital AV data stored in a data storage medium and transmitting to the display driving module for display on the display panel.

The data storage media reading module includes a host circuit module for reading the digital AV data stored in the data storage media and also includes a coding circuit electrically connected with the host circuit module for coding the digital AV data read by the host circuit module and for transmitting to the display driving module for reading.

The host circuit module includes at least one connection port and at least one host circuit.

The connection port includes a memory card slot and a USB connection seat for respective insertion of the data storage media including a memory card and a USB interface storage medium. The host circuit reads the digital AV data stored in the data storage media inserted in the connection port.

These and other embodiments, aspects and features of the invention will be better understood from a detailed description of the preferred embodiments of the invention, which are further described below in conjunction with the accompanying figures.

### BRIEF DESCRIPTION OF THE DRAWINGS

FIG. 1 shows a schematic view of an automotive display having a function of reading data storage media of the present invention; and

FIGS. 2 and 3 show perspective views of an automotive display having a function of reading data storage media in accordance with two different embodiments of the present invention.

### DETAILED DESCRIPTION OF THE PREFERRED EMBODIMENT

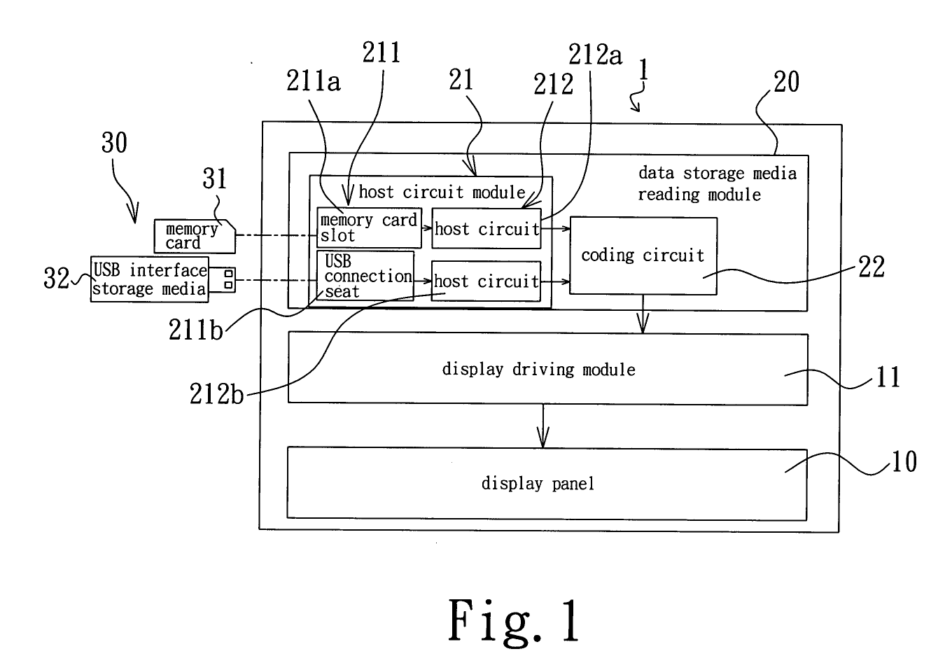

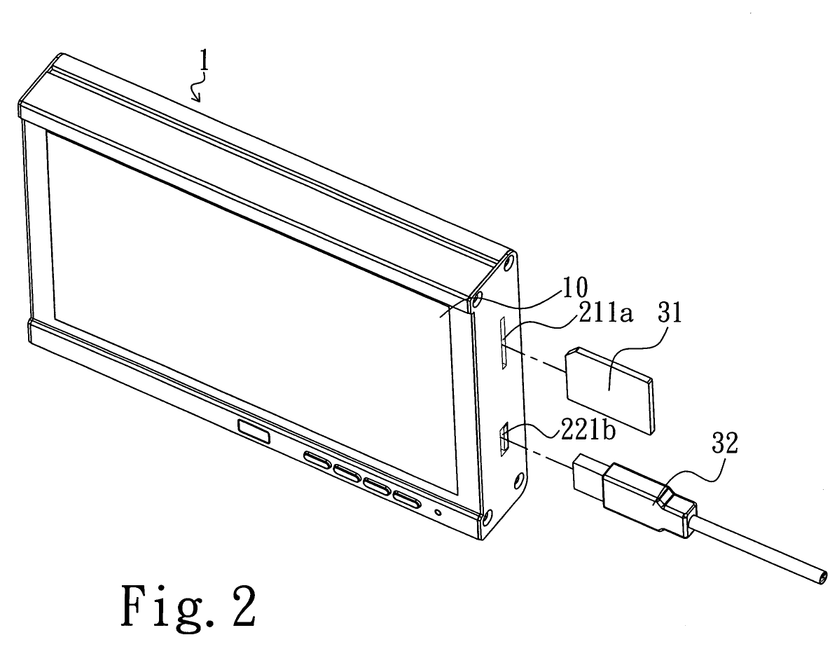

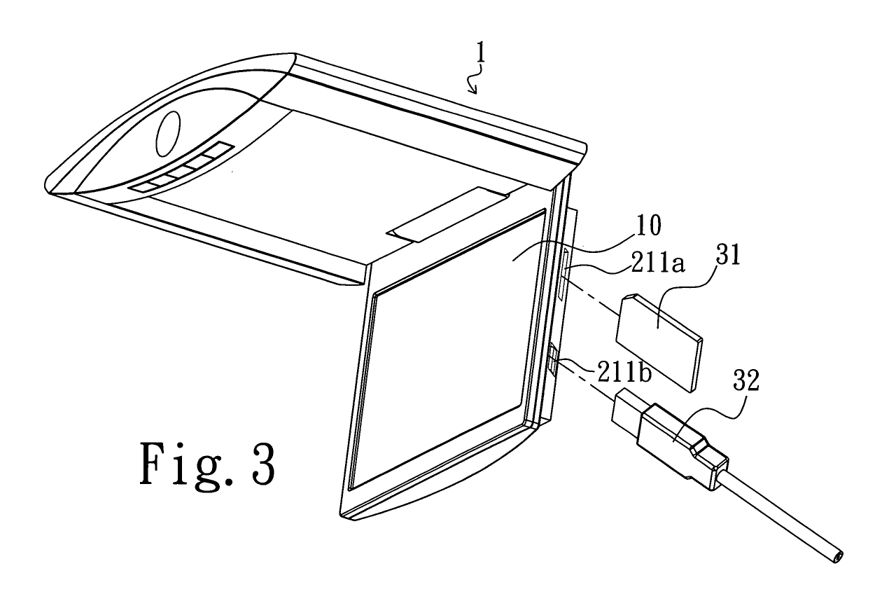

Referring to FIGS. 1-3, FIG. 1 shows a schematic view of an automotive display having a function of reading data storage media of the present invention; and FIGS. 2 and 3 show perspective views of an automotive display having a function of reading data storage media in accordance with two different embodiments of the present invention.

An automotive display having a function of reading data storage media of the present invention may be a suspended type (as shown in FIG. 3) or an embedded type (as shown in FIG. 2) of an automotive display and may be disposed at any proper position inside an automobile, for example, a roof of the automobile, a dashboard in front of the driver's seat, or a rear surface of a front seat.

As shown in the above-mentioned figures, the automotive display 1 having a function of reading data storage media of the present invention includes a display panel 10 and a display driving module 11. The display panel 10 is employed to display AV data. In this embodiment, the display panel 10 is a TFT LCD but may be another type of display such as an OLED. The display driving module 11 processes the AV data and transmits the AV data to the display panel 10 for display.

The automotive display 1 having a function of reading data storage media of the present invention is characterized in that a data storage media reading module 20 is electrically connected with the display driving module 11 within the display 1 for reading and coding digital AV data stored in a data storage medium 30 and for transmitting to the display driving module 11 for displaying on the display panel 10.

The data storage media reading module 20 includes a host circuit module 21 and a coding circuit 22. The host circuit module 21 is employed to read digital AV data stored in a data storage medium. The coding circuit 22 is electrically connected with the host circuit module 21 for coding the digital data read by the host circuit module 21 and for transmitting the data to the display driving module 11 for reading.

The host circuit module 21 includes at least one connection port 211 and at least one host circuit 212. The connection port 211 may be disposed at any one of side edges of the display 1 for insertion of the data storage media 30. The host circuit 212 electrically connects with the connection port 211 for reading the digital AV data stored in the data storage medium 30.

In use, the connection port 211 is a memory card slot 21 la and the data storage medium 30 is a memory card 31. Therefore, the host circuit 212a electrically connected with the memory card slot 211a reads digital AV data stored in the memory card 31. The memory card slot 211a may be selected from an SD slot, an MMC slot and a CF slot in accordance with the type of the memory card 31 to be read.

Furthermore, the connector 211 may be a USB connection seat 21 lb. The data storage medium 30 is a USB interface storage medium 32 (such as a USB portable drive or a hard disc).

Therefore, the host circuit 212b electrically connected with the USB connection seat 211b reads digital AV data stored in the USB interface storage medium 32. At this time, the host circuit 212b is a host circuit with a USB.

Alternatively, the connection port 211 may include a memory card slot 211a and a USB connection seat 32 and may simultaneously read data stored in the data storage media 30 including a memory card 31 and a USB interface storage medium 32.

The automotive display having a function of reading data storage media of the present invention only requires directly inserting the data storage medium 30, which stores data and may be the memory card 31 or the USB interface storage medium 32, into the connection port 211 at the side edge of the display 1, whereby the host circuit 212 reads the data stored in the data storage medium 30 and transmits the data to the coding circuit 22 for coding. Then, the coded data are transmitted to the display driving module 11, whereby the coded AV data are displayed on the display panel 10. The data reading manner of the present invention is different from that of the prior art which employs a read head of a player to read a compact disc, thereby preventing adversely affecting reading quality due to vibration or bouncing of an automobile.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. An automotive display having a function of reading data storage media being disposed inside an automobile, the automotive display comprising:
a display panel for displaying AV data; and
a display driving module for transmitting the AV data to the display panel for display;
wherein a data storage media reading module is electrically connected with the display driving module within the display for reading and coding digital AV data stored in at least one data storage medium and transmitting the digital AV data to the display driving module for display on the display panel.

2. The automotive display of claim 1, wherein the data storage media reading module includes:
a host circuit module for reading digital AV data stored in the data storage medium; and
a coding circuit electrically connected with the host circuit module for coding the digital AV data read by the host circuit module and transmitting the digital AV data to the display driving module for reading.

3. The automotive display of claim 2, wherein the host circuit module includes:
at least one connection port for insertion of the data storage medium; and
at least one host circuit electrically connecting the connection port for reading the digital AV data stored in the data storage medium.

4. The automotive display of claim 3, wherein the connection port is a memory card slot, and the data storage medium is a memory card 31.

5. The automotive display of claim 4, wherein the memory card slot is selected from an SD slot, an MMC slot and a CF slot in accordance with the type of the memory card to be read.

6. The automotive display of claim 3, wherein the connector is a USB connection seat, and the data storage medium is a USB interface storage medium.

7. The automotive display of claim 3, wherein the connection port includes a memory card slot and a USB connection seat, and the data storage medium includes a memory card and a USB interface storage medium.

8. The automotive display of claim 1, wherein the display is disposed inside a roof of the automobile.

9. The automotive display of claim 1, wherein the display is disposed at a rear surface of a front seat of the automobile.

10. The automotive display of claim 1, wherein the display is disposed at a dashboard of the driver's seat of the automobile.
